(19) United States
(12) Patent Application Publication
(10) Pub. No.: US 2023/0271850 A1
(43) Pub. Date: Aug. 31, 2023

(54) FUEL CELL SYSTEM, EXHAUST GAS PURIFICATION METHOD USING FUEL CELL, AND FUEL CELL DEVICE MODIFICATION METHOD

(71) Applicant: MITSUBISHI HEAVY INDUSTRIES, LTD., Tokyo (JP)

(72) Inventor: Katsuhiko YOKOHAMA, Tokyo (JP)

(73) Assignee: MITSUBISHI HEAVY INDUSTRIES, LTD., Tokyo (JP)

(21) Appl. No.: 17/922,121

(22) PCT Filed: May 20, 2021
(86) PCT No.: PCT/JP2021/019186

§ 371 Date: May 1, 2023

(30) Foreign Application Priority Data
May 27, 2020 (JP) 2020-092375

(51) Int. Cl. C02F 1/16; H01M 8/1246; H01M 8/04746; B01D 53/00

(52) U.S. Cl. CPC C02F 1/16; H01M 8/1246; H01M 8/04776; B01D 53/005; H01M 2008/1293

(57) ABSTRACT

A fuel cell system 2 is provided with: a contaminated exhaust gas line for supplying a contaminated exhaust gas containing a contaminant discharged from a facility; and a contaminated exhaust gas purification part for purifying the contaminated exhaust gas supplied from the contaminated exhaust gas line by using heat of reaction of a fuel cell.

### TECHNICAL FIELD

The present disclosure relates to a fuel cell system, an exhaust gas purification method using a fuel cell, and a fuel cell device modification method.

The present application claims priority based on Japanese Patent Application No. 2020-092375 filed on May 27, 2020, the entire content of which is incorporated herein by reference.

### BACKGROUND ART

Patent Document 1 discloses an air conditioner that removes odorous components adhering to indoor walls and curtains, inactivates allergens, viruses, and the like floating or adhering to a room, and sterilizes mold, bacteria, and the like.

### CITATION LIST

### Patent Literature

Patent Document 1: JP2008-281330A

### SUMMARY

### Problems to be Solved

For example, a facility such as a hospital that handles contaminants including bacteria and viruses can spread the contaminants if the contaminated exhaust gas emitted from the facility is not properly purified. However, it is not always easy to install a dedicated purification device for the sole purpose of purifying the contaminants, for example, due to the increase in installation space and cost.

In view of the above, an object of the present disclosure is to provide a fuel cell system, an exhaust gas purification method using a fuel cell, and a fuel cell device modification method whereby it is possible to purify a contaminant while generating electric power.

### Solution to the Problems

To achieve the above object, a fuel cell system according to the present disclosure is provided with: a contaminated exhaust gas line for supplying a contaminated exhaust gas containing a contaminant discharged from a facility; and a contaminated exhaust gas purification part for purifying the contaminated exhaust gas supplied from the contaminated exhaust gas line by using heat of reaction of a fuel cell.

To achieve the above object, an exhaust gas purification method using a fuel cell according to the present disclosure includes: a step of supplying a contaminated exhaust gas containing a contaminant discharged from a facility to a contaminated exhaust gas purification part; and a step of purifying the contaminated exhaust gas in the contaminated exhaust gas purification part by using heat of reaction of the fuel cell.

To achieve the above object, a fuel cell device modification method according to the present disclosure for modifying a fuel cell device including a fuel cell includes a step of connecting a contaminated exhaust gas line for supplying a contaminated exhaust gas discharged from a facility to an air inlet of the fuel cell.

### Advantageous Effects

The present disclosure provides a fuel cell system, an exhaust gas purification method using a fuel cell, and a fuel cell device modification method whereby it is possible to purify a contaminant while generating electric power.

### BRIEF DESCRIPTION OF DRAWINGS

FIG. 1 is a schematic diagram of a fuel cell system 2 (2A) according to an embodiment.

FIG. 2 is a schematic diagram of a fuel cell system 2 (2B) according to another embodiment.

FIG. 3 is a schematic diagram of a fuel cell system 2 (2C) according to another embodiment.

FIG. 4 is a schematic diagram of a fuel cell system 2 (2D) according to another embodiment.

FIG. 5 is a schematic diagram of a fuel cell system 2 (2E) according to another embodiment.

FIG. 6 is a schematic diagram of a fuel cell system 2 (2F) according to another embodiment.

FIG. 7 is a schematic diagram of a fuel cell system 2 (2G) according to another embodiment.

### DETAILED DESCRIPTION

Embodiments of the present disclosure will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

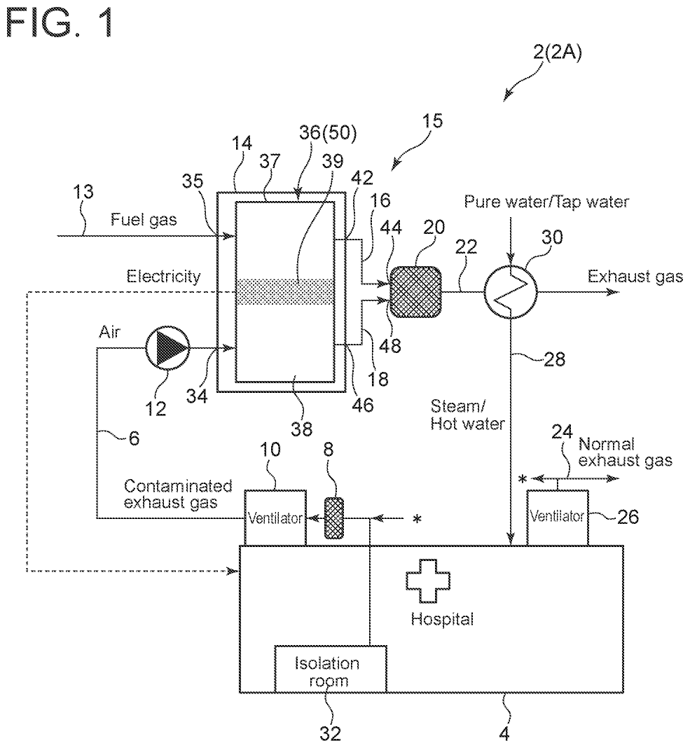

FIG. 1 is a schematic diagram of a fuel cell system 2 (2A) according to an embodiment. In the example shown in FIG. 1, the fuel cell system 2 is configured to purify a contaminated exhaust gas containing a contaminant discharged from a hospital 4 as the facility.

The fuel cell system 2 shown in FIG. 1 includes a contaminated exhaust gas line 6, a filter 8, a ventilator 10, a compressor 12, a fuel gas line 13, a SOFC 14, an exhaust fuel gas line 16, an exhaust air line 18, a combustor 20, a combustion gas line 22, a normal exhaust gas line 24, a ventilator 26, a feed water line 28, and a heat exchanger 30. The SOFC 14 is a solid oxide fuel cell. Here, the SOFC 14, the exhaust fuel gas line 16, the exhaust air line 18, the combustor 20, the combustion gas line 22, the feed water line 28, and the heat exchanger 30 constitute an SOFC device 15 (fuel cell device).

The contaminated exhaust gas line 6 is composed of a pipe and is configured to supply a contaminated exhaust gas containing a contaminant discharged from the hospital 4 to an air inlet 34 of the SOFC 14. The contaminant includes, for example, bacteria or viruses. One end of the contaminated exhaust gas line 6 is connected to an isolation room 32 for isolating an infectious disease patient or the like in the hospital 4, and the other end of the contaminated exhaust gas line 6 is connected to the air inlet 34 of the SOFC 14.

The filter 8 is disposed between the isolation room 32 and the ventilator 10 in the contaminated exhaust gas line 6. The filter 8 is configured to remove some or all of micro particles in the contaminated exhaust gas flowing through the contaminated exhaust gas line 6.

The ventilator 10 is disposed between the filter 8 and the compressor 12 in the contaminated exhaust gas line 6. The ventilator 10 is configured to draw the contaminated exhaust gas from the isolation room 32 through the filter 8 so that the isolation room 32 functions as, for example, a depressurized room.

The compressor 12 is disposed between the ventilator 10 and the SOFC 14 in the contaminated exhaust gas line 6. The compressor 12 pressurizes the contaminated exhaust gas flowing through the contaminated exhaust gas line 6 and supplies it to the air inlet 34 of the SOFC 14.

The fuel gas line 13 is composed of a pipe and is configured to supply a fuel gas to a fuel gas inlet 35 of the SOFC 14. Examples of the fuel gas that can be supplied to the fuel gas inlet 35 of the SOFC 14 and used include hydrogen (H₂), carbon monoxide (CO), hydrocarbon gas such as methane (CH₄), biogas, city gas, natural gas, and gasified gas produced by a gasification facility using carbon-containing raw materials such as petroleum, methanol, and coal alone or mixtures thereof.

The SOFC 14 includes a power generation part 36 configured to generate power at a predetermined operating temperature (e.g., 500° C. to 900° C.), using the fuel gas supplied from the fuel gas line 13 through the fuel gas inlet 35 and the contaminated exhaust gas (more strictly speaking, oxygen in the contaminated exhaust gas) as an oxidant supplied from the contaminated exhaust gas line 6 through the air inlet 34. As the air supplied to the SOFC, all or part of the contaminated air from the ventilator 10 and all or part of normal exhaust gas from the ventilator 26 are used.

The power generation part 36 includes an anode 37, a cathode 38, and an electrolyte 39. The fuel gas is supplied from the fuel gas line 13 to the anode 37 through the fuel gas inlet 35, and the contaminated exhaust gas is supplied from the contaminated exhaust gas line 6 to the cathode 38 through the air inlet 34 to generate power at the predetermined operating temperature. Here, the power generation part 36 of the SOFC 14 constitutes a contaminated exhaust gas purification part 50 which purifies the contaminated exhaust gas supplied from the contaminated exhaust gas line 6 by using heat of reaction of the SOFC 14 (heat of electrochemical reaction using the fuel gas and oxygen in the contaminated exhaust). The electric power generated by the SOFC 14 is converted into a predetermined electric power by a power conversion device (e.g., inverter) of a power conditioner (not shown) or a transformer, and is supplied to the hospital 4 (outside the fuel cell system 2) and used in the hospital 4.

The exhaust fuel gas line 16 is composed of a pipe and is configured to supply an exhaust fuel gas discharged from the SOFC 14 to an exhaust fuel gas inlet 44 of the combustor 20. One end of the exhaust fuel gas line 16 is connected an exhaust fuel gas outlet 42 of the SOFC 14, and the other end of the exhaust fuel gas line 16 is connected to the exhaust fuel gas inlet 44 of the combustor 20.

The exhaust air line 18 is composed of a pipe and is configured to supply an exhaust air discharged from the SOFC 14 to an exhaust air inlet 48 of the combustor 20. One end of the exhaust air line 18 is connected to an exhaust air outlet 46 of the SOFC 14, and the other end of the exhaust air line 18 is connected to the exhaust air inlet 48 of the combustor 20.

The combustor 20 combusts the exhaust gas of the SOFC 14. In the illustrated embodiment, the exhaust fuel gas supplied from the exhaust fuel gas line 16 and the exhaust air supplied from the exhaust air line 18 are mixed and combusted to generate the combustion gas. The combustion gas generated in the combustor 20 is supplied to the heat exchanger 30 through the combustion gas line 22, and exchanges heat with water (e.g., pure water or tap water) flowing through the feed water line 28 at the heat exchanger 30 to heat the water. The water flowing through the feed water line 28 is heated at the heat exchanger 30 to become steam or hot water, and is supplied to the hospital 4.

The normal exhaust gas line 24 is composed of a pipe and is configured to discharge a normal exhaust gas discharged from a place other than the isolation room 32 in the hospital 4 through the ventilator 26 to the outside of the hospital 4.

According to the above configuration, the contaminated exhaust gas supplied from the isolation room 32 of the hospital 4 through the contaminated exhaust gas line 6 can be purified by using heat of reaction of the SOFC 14, so that the contaminated exhaust gas can be purified while generating electric power by the SOFC 14. For example, the amount of bacteria or viruses contained in the contaminated exhaust gas discharged from the hospital 4 can be significantly reduced by killing the bacteria or viruses in the contaminated exhaust gas while utilizing the electric power generated by the SOFC 14 in the hospital 4. Thus, it is possible to reduce the health risks of people coming in and out of the hospital 4, nearby residents, and others.

Further, since the SOFC 14 takes in a large amount of air through the air inlet 34 and uses it for power generation, it can purify a large amount of contaminated air. In contrast, purifying the contaminated exhaust gas with, for example, a combustor alone requires a large-scale combustor, which generates a large amount of CO₂ and causes high vibration and noise.

Further, the SOFC 14 can be operated 24 hours a day, causes low vibration and noise during operation, and emits only water when hydrogen is used as fuel. Thus, the SOFC 14 can be suitably used in the hospital 4. Additionally, the SOFC 14 can operate with fuel gas even in the event of a power failure, and water can be obtained from the SOFC 14 even if the water supply is cut off. Thus, the introduction of the fuel cell system 2 has significant advantages in terms of disaster prevention.

Further, by modifying an existing SOFC device 15 including the SOFC 14 to connect the contaminated exhaust gas line 6 to the air inlet 34 of the SOFC 14, the fuel cell system 2 can be easily constructed.

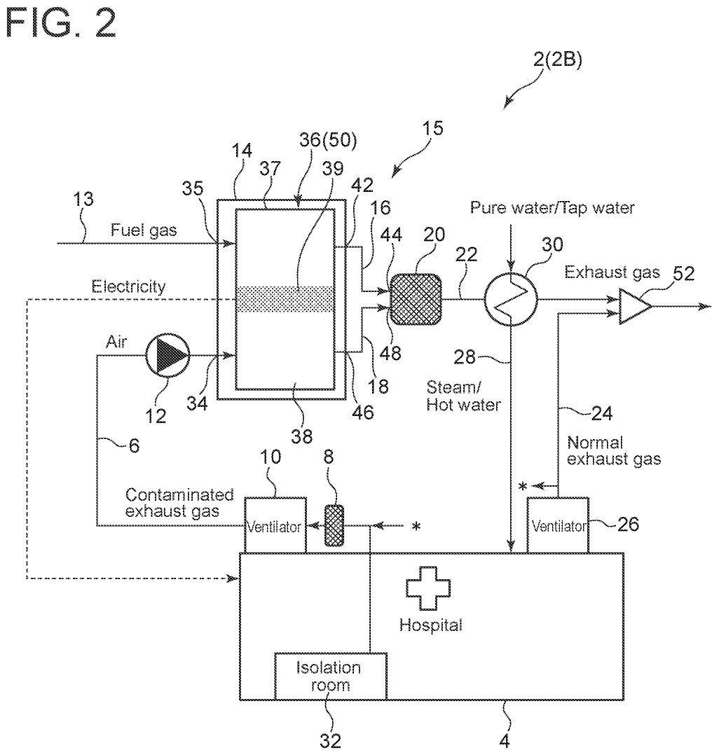

FIG. 2 is a schematic diagram of a fuel cell system 2 (2B) according to another embodiment. In the fuel cell system 2 (2B) shown in FIG. 2, unless otherwise noted, reference signs common to the components of the fuel cell system 2 (2A) shown in FIG. 1 indicate the same components as those of the fuel cell system 2 (2A) shown in FIG. 1, and the explanation is omitted.

The fuel cell system 2 (2B) shown in FIG. 2 differs from the fuel cell system 2 (2A) in that it includes a mixer 52 for mixing the combustion gas flowing through the combustion gas line 22 and the normal exhaust gas flowing through the normal exhaust gas line 24. In the illustrated embodiment, the mixer 52 is disposed downstream of the heat exchanger 30 in the combustion gas line 22. According to this configuration, the combustion gas discharged from the combustor 20 and the normal exhaust gas discharged from the hospital 4 are mixed by the mixer 52 and discharged.

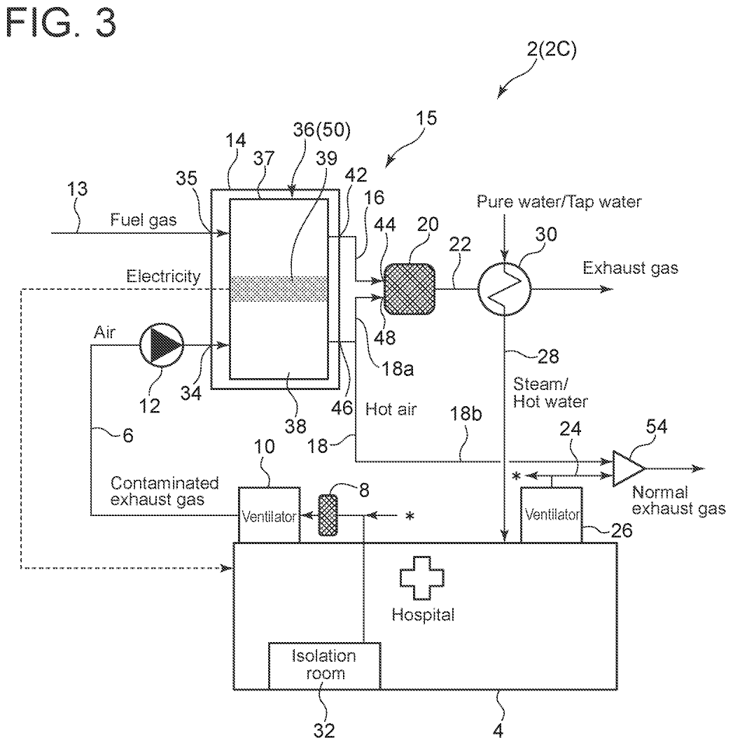

FIG. 3 is a schematic diagram of a fuel cell system 2 (2C) according to another embodiment. In the fuel cell system 2 (2C) shown in FIG. 3, unless otherwise noted, reference signs common to the components of the fuel cell system 2 (2A) shown in FIG. 1 indicate the same components as those of the fuel cell system 2 (2A) shown in FIG. 1, and the explanation is omitted.

The fuel cell system 2 (2C) shown in FIG. 3 differs from the fuel cell system 2 (2A) in the configuration of the exhaust air line 18 and the normal exhaust gas line 24 and the presence of a mixer 54. In the illustrated embodiment, the exhaust air line 18 includes a first exhaust air line portion 18a connecting the exhaust air outlet 46 of the SOFC 14 and the combustor 20, and a second exhaust air line portion 18b branched from the first exhaust air line portion 18a and connected to the mixer 54. Further, the normal exhaust gas line 24 is connected to the mixer 54 on the downstream side of the ventilator 26. According to this configuration, the hot exhaust air (hot air) supplied from the SOFC 14 to the mixer 54 through the second exhaust air line portion 18b and the normal exhaust gas supplied from the hospital 4 to the mixer 54 through the normal exhaust gas line 24 are mixed by the mixer 54 and discharged.

The combustor 20 mixes the exhaust fuel gas supplied from the SOFC 14 through the exhaust fuel gas line 16 and the exhaust air supplied from the SOFC 14 through the first exhaust air line portion 18a and combusts the mixture to generate the combustion gas.

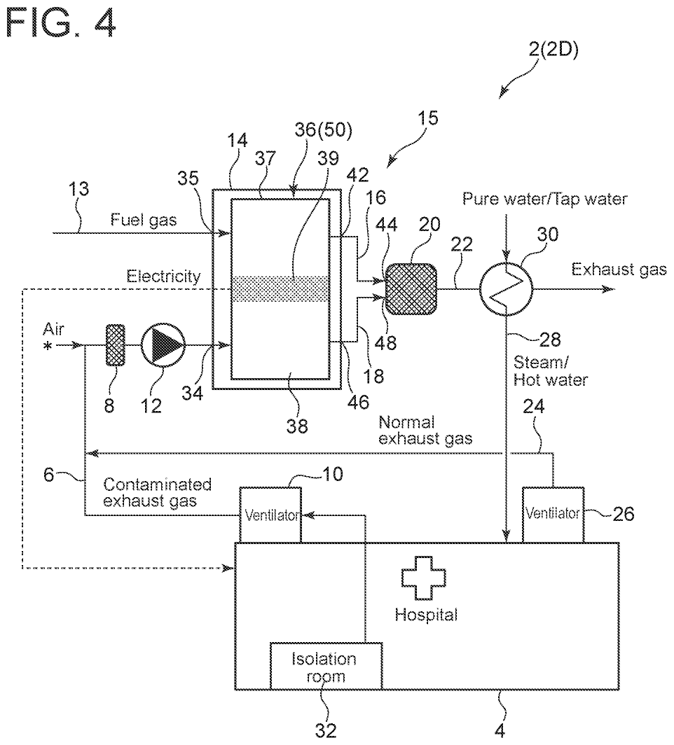

FIG. 4 is a schematic diagram of a fuel cell system 2 (2D) according to another embodiment. In the fuel cell system 2 (2D) shown in FIG. 2, unless otherwise noted, reference signs common to the components of the fuel cell system 2 (2A) shown in FIG. 1 indicate the same components as those of the fuel cell system 2 (2A) shown in FIG. 1, and the explanation is omitted.

The fuel cell system 2 (2D) shown in FIG. 4 differs from the fuel cell system 2 (2A) in the position of the filter 8 and the configuration of the normal exhaust gas line 24. In the illustrated embodiment, the filter 8 is disposed downstream of the ventilator 10 in the contaminated exhaust gas line 6, and the normal exhaust gas line 24 joins the contaminated exhaust gas line 6 at a position between the ventilator 10 and the filter 8.

According to this configuration, both the contaminated exhaust gas discharged from the isolation room 32 of the hospital 4 and the normal exhaust gas discharged from a place other than the isolation room 32 in the hospital 4 are supplied to the cathode 38 of the SOFC 14 and purified by using heat of reaction of the SOFC 14.

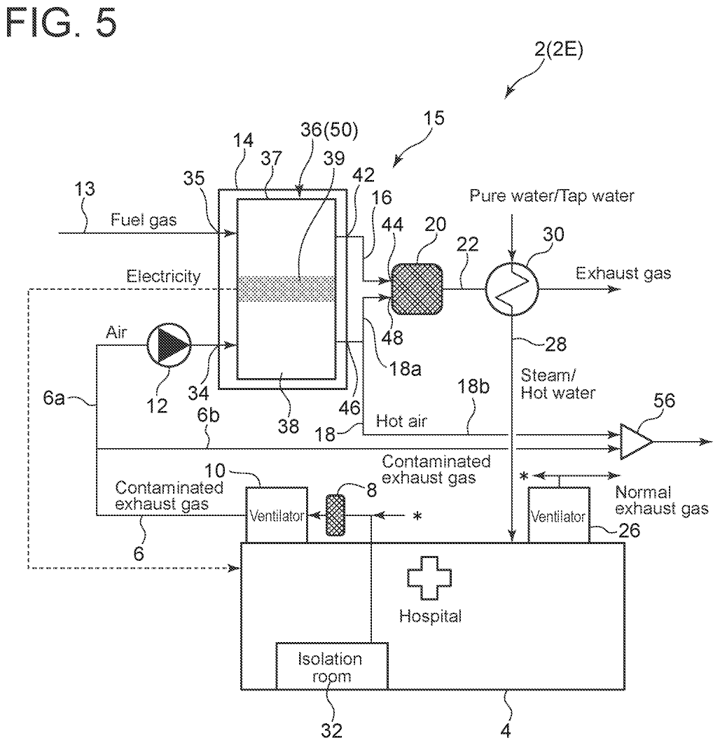

FIG. 5 is a schematic diagram of a fuel cell system 2 (2E) according to another embodiment. In the fuel cell system 2 (2E) shown in FIG. 5, unless otherwise noted, reference signs common to the components of the fuel cell system 2 (2A) shown in FIG. 1 indicate the same components as those of the fuel cell system 2 (2A) shown in FIG. 1, and the explanation is omitted.

The fuel cell system 2 (2E) shown in FIG. 5 differs from the fuel cell system 2 (2A) in the configuration of the contaminated exhaust gas line 6 and the exhaust air line 18 and the presence of a mixer 56. In the illustrated embodiment, the contaminated exhaust gas line 6 includes a first contaminated exhaust gas line portion 6a connecting the isolation room 32 of the hospital 4 and the air inlet 34 of the SOFC 14, and a second contaminated exhaust gas line portion 6b branched from the first contaminated exhaust gas line portion 6a and connected to the mixer 56. Further, the exhaust air line 18 includes a first exhaust air line portion 18a connecting the exhaust air outlet 46 of the SOFC 14 and the combustor 20, and a second exhaust air line portion 18b branched from the first exhaust air line portion 18a and connected to the mixer 56.

According to this configuration, the contaminated exhaust gas supplied from the isolation room 32 of the hospital 4 to the mixer 56 through the second contaminated exhaust gas line portion 6b and the hot exhaust air (hot air) supplied from the SOFC 14 to the mixer 56 through the second exhaust air line portion 18b are mixed by the mixer 56 and discharged. In this case, the mixer 56 functions as a heat exchange part for direct heat exchange between the exhaust gas (hot exhaust air) of the SOFC 14 and the contaminated exhaust gas. Therefore, in the embodiment shown in FIG. 5, each of the power generation part 36 of the SOFC 14 and the mixer 56 constitutes the contaminated exhaust gas purification part 50 which purifies the contaminated exhaust gas by using heat of reaction of fuel cell of the SOFC 14.

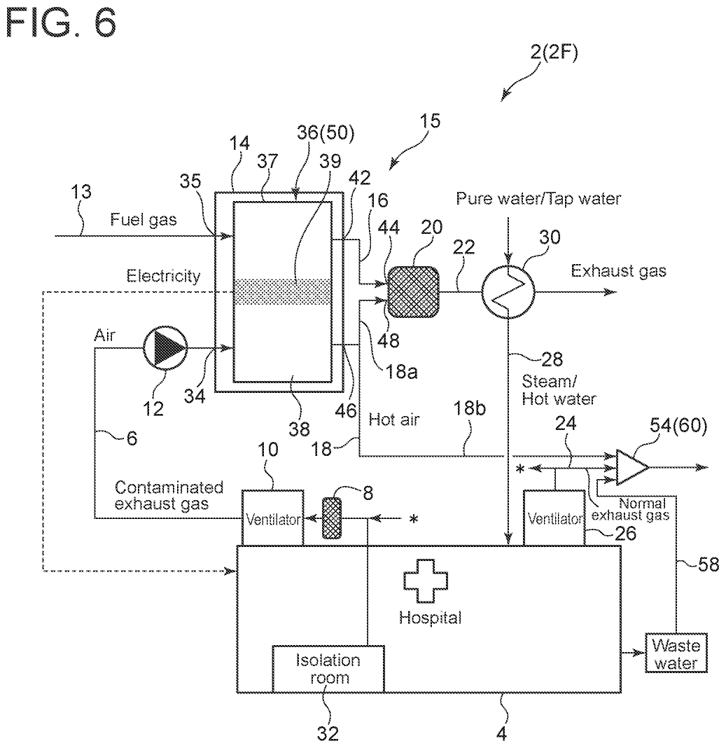

FIG. 6 is a schematic diagram of a fuel cell system 2 (2F) according to another embodiment. In the fuel cell system 2 (2F) shown in FIG. 6, unless otherwise noted, reference signs common to the components of the fuel cell system 2 (2C) shown in FIG. 3 indicate the same components as those of the fuel cell system 2 (2C) shown in FIG. 3, and the explanation is omitted.

The fuel cell system 2 (2F) shown in FIG. 6 differs from the fuel cell system 2 (2C) shown in FIG. 3 in that it includes a contaminated wastewater line 58 for supplying a contaminated wastewater containing a contaminant discharged from the hospital 4 and a contaminated wastewater purification part 60 for purifying the contaminated wastewater supplied from the contaminated wastewater line 58 by using heat of reaction of the fuel cell. In the fuel cell system 2 (2F) shown in FIG. 6, the mixer 54 constitutes the contaminated wastewater purification part 60. In the configuration shown in FIG. 6, the contaminated wastewater line 58 supplies the contaminant discharged from the hospital 4 to the mixer 54. The mixer 54 is supplied with the contaminated wastewater supplied from the contaminated wastewater line 58, the hot exhaust air supplied from the exhaust air line 18, and the normal exhaust gas supplied from the normal exhaust gas line 24, and the heat of the hot exhaust air supplied from the exhaust air line 18 is used to purify the contaminated wastewater. The contaminated wastewater may be discharged to the outside via a reheat exchanger or may be evaporated.

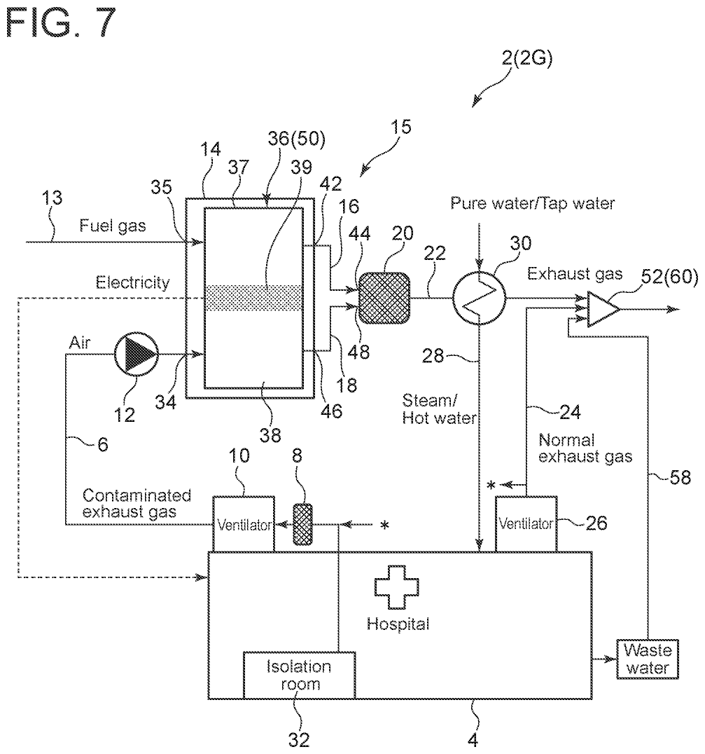

FIG. 7 is a schematic diagram of a fuel cell system 2 (2G) according to another embodiment. In the fuel cell system 2 (2G) shown in FIG. 6, unless otherwise noted, reference signs common to the components of the fuel cell system 2 (2B) shown in FIG. 2 indicate the same components as those of the fuel cell system 2 (2B) shown in FIG. 2, and the explanation is omitted.

The fuel cell system 2 (2G) shown in FIG. 7 differs from the fuel cell system 2 (2B) shown in FIG. 3 in that it includes a contaminated wastewater line 58 for supplying a contaminated wastewater containing a contaminant discharged from the hospital 4 and a contaminated wastewater purification part 60 for purifying the contaminated wastewater supplied from the contaminated wastewater line 58 by using heat of reaction of the fuel cell. In the fuel cell system 2 (2G) shown in FIG. 6, the mixer 52 constitutes the contaminated wastewater purification part 60. In the configuration shown in FIG. 7, the contaminated wastewater line 58 supplies the contaminant discharged from the hospital 4 to the mixer 52. The mixer 52 is supplied with the contaminated wastewater supplied from the contaminated wastewater line 58, the hot combustion gas supplied from the combustion gas line 22, and the normal exhaust gas supplied from the normal exhaust gas line 24, and the heat of the hot combustion gas supplied from the combustion gas line 22 is used to purify the contaminated wastewater. The contaminated wastewater may be discharged to the outside via a reheat exchanger or may be evaporated.

The present disclosure is not limited to the embodiments described above, but includes modifications to the embodiments described above, and embodiments composed of combinations of those embodiments.

For example, in the fuel cell system 2 (2A to 2G), the filter 8, the ventilators 10, 26, the compressor 12, the combustor 20, the combustion gas line 22, the normal exhaust gas line 24, the feed water line 28, the heat exchanger 30, and the mixers 52, 54 are not essential and may not be provided.

Further, in the fuel cell system 2 (2A to 2G), the SOFC having a relatively high operating temperature has been described as an example of the fuel cell. However, the fuel cell is not limited to the SOFC, but may be a phosphoric acid fuel cell (PAFC), a molten carbonate fuel cell (MCFC), or the like. However, from the perspective of effectively purifying the contaminated exhaust gas by using heat of reaction of the fuel cell, the operating temperature of the fuel cell is desirably 100° C. or higher.

Further, in the fuel cell system 2 (2A to 2G), when the amount of the contaminated exhaust gas supplied from the contaminated exhaust gas line 6 to the air inlet 34 of the SOFC 14 is less than necessary amount, the atmospheric air or normal exhaust gas from the normal exhaust gas line 24 may be supplied to the air inlet 34 of the SOFC 14. In this case, for example, the atmospheric air or normal exhaust sucked from the upstream side of the filter 8 in the contaminated exhaust gas line 6 may be supplied to the SOFC 14.

Further, in the fuel cell system 2 (2A to 2G), the hospital 4 has been described as an example of the facility from which the contaminated exhaust gas containing a contaminant such as bacteria, viruses, or an odor-producing substance that affects a living organism (i.e., a toxic substance that affects a living organism) is discharged. However, the facility from which the contaminated exhaust gas is discharged is not limited to the hospital, but may be, for example, a facility into which the contaminant is introduced, a facility in which the contaminant proliferates, or a facility in which the contaminant is created. For example, it may be a laboratory, a factory, or an isolation facility that handles the contaminant such as bacteria or viruses. Further, the contaminant contained in the contaminated exhaust gas to be purified by the contaminated exhaust gas purification part 50 may include only bacteria, only viruses, only an odor-producing substance, only other harmful substances, or more than one type of these contaminants.

Further, in the fuel cell system 2 (2A to 2G), the configuration in which electric power generated by the SOFC 14 is supplied to the hospital 4 has been described, but part or all of the electric power generated by the SOFC 14 may be sold to an electric power company or used in other facilities attached to the hospital.

Further, in the fuel cell system 2 (2E) shown in FIG. 5, the mixer 56 as the contaminated exhaust gas purification part is configured to perform direct heat exchange between the exhaust gas of the SOFC 14 and the contaminated exhaust gas, but instead of the mixer 56, a heat exchange part (heat exchanger) configured to perform indirect heat exchange between the exhaust gas of the SOFC 14 and the contaminated exhaust gas may be provided.

That is, the contaminated exhaust gas purification part may purify the contaminated exhaust gas through direct heat exchange by mixing the exhaust gas of the SOFC 14 and the contaminated exhaust gas, or may purify the contaminated exhaust gas through indirect heat exchange in which heat is exchanged via a heat transfer tube of the heat exchanger without mixing the exhaust gas of the SOFC 14 and the contaminated exhaust gas.

The contents described in the above embodiments would be understood as follows, for instance.

(1) A fuel cell system (e.g., the above-described fuel cell system 2 (2A to 2G)) according to the present disclosure is provided with: a contaminated exhaust gas line (e.g., the above-described contaminated exhaust gas line 6) for supplying a contaminated exhaust gas containing a contaminant discharged from a facility (e.g., the above-described hospital 4 or laboratory); and a contaminated exhaust gas purification part (e.g., the above-described contaminated exhaust gas purification part 50, i.e., the power generation part 36 of the SOFC 14 or the mixer 56) for purifying the contaminated exhaust gas supplied from the contaminated exhaust gas line by using heat of reaction of a fuel cell (e.g., the above-described SOFC 14).

With the fuel cell system described in the above (1), the contaminated exhaust gas supplied from the facility through the contaminated exhaust gas line can be purified by using heat of reaction of the fuel cell, so that the contaminated exhaust gas can be purified while generating electric power by the fuel cell.

(2) In some embodiments, in the fuel cell system described in the above (1), the contaminant includes a substance that affects a living organism such as bacteria, viruses, or an odor-producing substance.

With the fuel cell system described in the above (2), the amount of substances that affect a living organism such as bacteria, viruses, or an odor-producing substance discharged from the facility can be reduced by using heat of reaction of the fuel cell, so that the contaminated exhaust gas can be purified while generating electric power by the fuel cell. The odor-producing substance means a specified odor substance as defined in the offensive odor control law, including, for example, ammonia, hydrogen sulfide, and acetaldehyde.

(3) In some embodiments, in the fuel cell system described in the above (1) or (2), the facility is a facility into which the contaminant is introduced, a facility in which the contaminant proliferates, or a facility in which the contaminant is created.

With the fuel cell system described in the above (3), electric power can be generated while purifying the contaminated exhaust gas discharged from the facility into which the contaminant is introduced, the facility in which the contaminant proliferates, or the facility in which the contaminant is created.

(4) In some embodiments, in the fuel cell system described in any one of the above (1) to (3), the facility is a hospital or a laboratory, a factory, or an isolation facility that handles the contaminant.

With the fuel cell system described in the above (4), electric power can be generated while purifying the contaminated exhaust gas discharged from the hospital or the laboratory, the factory, or the isolation facility that handles the contaminant. For example, the amount of bacteria or viruses contained in the contaminated exhaust gas discharged from the hospital, the laboratory, the factory, or the isolation facility can be reduced by killing the bacteria or viruses in the contaminated exhaust gas while utilizing the electric power generated by the fuel cell in the hospital or the laboratory. Thus, it is possible to reduce the health risks of people coming in and out of the hospital, the laboratory, the factory, or the isolation facility, nearby residents, and others.

Further, the fuel cell can be operated 24 hours a day, causes low vibration and noise during operation, and emits only water. Thus, the fuel cell can be suitably used especially in the hospital. Additionally, the fuel cell can operate with fuel gas even in the event of a power failure, and water can be obtained from the fuel cell even if the water supply is cut off, so the introduction of the fuel cell system has significant advantages in terms of disaster prevention.

(5) In some embodiments, in the fuel cell system described in any one of the above (1) to (4), the contaminated exhaust gas purification part is a power generation part (e.g., the above-described power generation part 36) of the fuel cell.

With the fuel cell system described in the above (5), the contaminated exhaust gas can be effectively purified by directly using heat of reaction of the power generation part of the fuel cell, while generating electric power by the fuel cell.

(6) In some embodiments, in the fuel cell system described in the above (5), the contaminated exhaust gas line is configured to supply the contaminated exhaust gas to a cathode (e.g., the above-described cathode 38) of the power generation part.

With the fuel cell system described in the above (6), the contaminated exhaust gas can be effectively purified by directly using heat of reaction of the fuel cell, using oxygen in the contaminated exhaust gas as an oxidant in the fuel cell.

(7) In some embodiments, in the fuel cell system described in any one of the above (1) to (4), the contaminated exhaust gas purification part is a heat exchange part (e.g., the above-described mixer 56) configured to perform direct heat exchange or indirect heat exchange between an exhaust gas of the fuel cell and the contaminated exhaust gas.

With the fuel cell system described in the above (7), the heat of reaction of the fuel cell can be recovered from the exhaust gas of the fuel cell to heat the contaminated exhaust gas and purify it.

(8) In some embodiments, in the fuel cell system described in any one of the above (1) to (7), an operating temperature of the fuel cell is 100° C. or higher.

With the fuel cell system described in the above (8), the amount of substances that affect a living organism such as bacteria, viruses, or an odor-producing substance discharged from the facility can be effectively reduced by using heat of reaction of the fuel cell, so that the contaminated exhaust gas can be effectively purified while generating electric power by the fuel cell. Examples of the case where the operating temperature of the fuel cell is 100° C. or higher include operating temperatures during the minimum load operation of the SOFC.

Further, examples of the case where the operating temperature of the fuel cell is 400° C. or higher include operating temperatures at 50% load operation of the SOFC or when using a high-efficiency SOFC (model that can operate at lower temperatures).

(9) In some embodiments, in the fuel cell system described in the above (8), an operating temperature of the fuel cell is 400° C. or higher.

With the fuel cell system described in the above (9), the amount of substances that affect a living organism such as bacteria, viruses, or an odor-producing substance discharged from the facility can be reduced effectively by using heat of reaction of the fuel cell, so that the contaminated exhaust gas can be effectively purified while generating electric power by the fuel cell.

(10) In some embodiments, in the fuel cell system described in any one of the above (1) to (9), the fuel cell is a solid oxide fuel cell (e.g., the above-described SOFC 14).

With the fuel cell system described in the above (10), since the operating temperature of the solid oxide fuel cell is relatively high among fuel cells, the contaminated exhaust gas can be effectively purified.

(11) In some embodiments, in the fuel cell system described in any one of the above (1) to (5) and (7) to (10), the fuel cell system further includes a combustor (e.g., the above-described combustor 20) for burning an exhaust gas of the fuel cell.

With the fuel cell system described in the above (11), the contaminated exhaust gas can be effectively purified by burning the exhaust gas. Further, if a heat exchanger is disposed downstream of the combustor to recover heat from the combustion gas generated in the combustor, the heat can be effectively recovered.

(12) In some embodiments, in the fuel cell system described in the above (6), the fuel cell system further includes a combustor (e.g., the above-described combustor 20) for burning an exhaust gas of the fuel cell.

With the fuel cell system described in the above (12), the contaminated exhaust gas supplied from the facility to the fuel cell and purified by heat of reaction of the fuel cell is discharged from the fuel cell and further purified by the combustor. Thus, the contaminated exhaust gas from the facility can be purified more reliably.

(13) In some embodiments, in the fuel cell system described in any one of the above (1) to (12), the fuel cell system further includes a compressor disposed in the contaminated exhaust gas line.

With the fuel cell system described in the above (13), the reaction in the fuel cell can be promoted by compressing the contaminated exhaust gas with the compressor and supplying it to the fuel cell.

(14) In some embodiments, in the fuel cell system described in any one of the above (1) to (13), the fuel cell system further includes: a contaminated wastewater line (e.g., the above-described contaminated wastewater line 58) for supplying a contaminated wastewater containing a contaminant discharged from the facility; and a contaminated wastewater purification part (e.g., the above-described contaminated wastewater purification part 60) for purifying the contaminated wastewater supplied from the contaminated wastewater line by using heat of reaction of the fuel cell.

With the fuel cell system described in the above (14), the contaminated wastewater supplied from the facility through the contaminated wastewater line can be purified by using heat of reaction of the fuel cell, so that the contaminated wastewater can be purified while generating electric power by the fuel cell.

(15) An exhaust gas purification method using a fuel cell according to an embodiment of the present disclosure includes: a step of supplying a contaminated exhaust gas containing a contaminant discharged from a facility (e.g., the above-described hospital 4 or laboratory) to a contaminated exhaust gas purification part (e.g., the above-described contaminated exhaust gas purification part 50, i.e., the power generation part 36 of the SOFC 14 or the mixer 56); and a step of purifying the contaminated exhaust gas in the contaminated exhaust gas purification part by using heat of reaction of the fuel cell (e.g., the above-described SOFC 14).

With the exhaust gas purification method described in the above (15), the contaminated exhaust gas discharged from the facility can be purified by using heat of reaction of the fuel cell, so that the contaminated exhaust gas can be purified while generating electric power by the fuel cell.

(16) A fuel cell device modification method according to an embodiment of the present disclosure is a method for modifying a fuel cell device (e.g., the above-described SOFC device 15) including a fuel cell (e.g., the above-described SOFC 14) to a fuel cell system (e.g., the above-described fuel cell system 2 (2A to 2E)) for purifying a contaminated exhaust gas discharged from a facility (e.g., the above-described hospital 4, laboratory, factory, or isolation facility), including a step of connecting a contaminated exhaust gas line (e.g., the above-described contaminated exhaust gas line 6) for supplying the contaminated exhaust gas discharged from the facility to an air inlet (e.g., the above-described air inlet 34) of the fuel cell.

With the fuel cell device modification method described in the above (16), by modifying an existing fuel cell device to connect the contaminated exhaust gas line to the air inlet of the fuel cell, the fuel cell system capable of purifying the contaminated exhaust gas while generating electric power can be easily constructed.

### REFERENCE SIGNS LIST

2 Fuel cell system
4 Hospital
6 Contaminated exhaust gas line
6a First contaminated exhaust gas line portion
6b Second contaminated exhaust gas line portion
8 Filter
10, 26 Ventilator
12 Compressor
13 Fuel gas line
14 SOFC (Solid oxide fuel cell)
15 SOFC device
16 Exhaust fuel gas line
18 Exhaust air line
18a First exhaust air line portion
18b Second exhaust air line portion
20 Combustor
22 Combustion gas line
24 Normal exhaust gas line
28 Feed water line
30 Heat exchanger
32 Isolation room
34 Air inlet
35 Fuel gas inlet
36 Power generation part
37 Anode
38 Cathode
39 Electrolyte
42 Exhaust fuel gas outlet
44 Exhaust fuel gas inlet
46 Exhaust air outlet
48 Exhaust air inlet
50 Contaminated exhaust gas purification part
52, 54, 56 Mixer
58 Contaminated wastewater line
60 Contaminated wastewater purification part

1. A fuel cell system, comprising:
a contaminated exhaust gas line for supplying a contaminated exhaust gas containing a contaminant discharged from a facility; and
a contaminated exhaust gas purification part for purifying the contaminated exhaust gas supplied from the contaminated exhaust gas line by using heat of reaction of a fuel cell.

2. The fuel cell system according to claim 1,
wherein the contaminant includes a substance that affects a living organism such as bacteria, viruses, or an odor-producing substance.

3. The fuel cell system according to claim 1 or 2,
wherein the facility is a facility into which the contaminant is introduced, a facility in which the contaminant proliferates, or a facility in which the contaminant is created.

4. The fuel cell system according to any one of claims 1 to 3,
wherein the facility is a hospital or a laboratory, a factory, or an isolation facility that handles the contaminant.

5. The fuel cell system according to any one of claims 1 to 4,
wherein the contaminated exhaust gas purification part is a power generation part of the fuel cell.

6. The fuel cell system according to claim 5,
wherein the contaminated exhaust gas line is configured to supply the contaminated exhaust gas to a cathode of the power generation part.

7. The fuel cell system according to any one of claims 1 to 4,
wherein the contaminated exhaust gas purification part is a heat exchange part configured to perform direct heat exchange or indirect heat exchange between an exhaust gas of the fuel cell and the contaminated exhaust gas.

8. The fuel cell system according to any one of claims 1 to 7,
wherein an operating temperature of the fuel cell is 100° C. or higher.

9. The fuel cell system according to claim 8,
wherein the operating temperature of the fuel cell is 400° C. or higher.

10. The fuel cell system according to any one of claims 1 to 9,
wherein the fuel cell is a solid oxide fuel cell.

11. The fuel cell system according to any one of claims 1 to 5 and 7 to 10, further comprising a combustor for burning an exhaust gas of the fuel cell.

12. The fuel cell system according to claim 6, further comprising a combustor for burning an exhaust gas of the fuel cell.

13. The fuel cell system according to any one of claims 1 to 12, further comprising a compressor disposed in the contaminated exhaust gas line.

14. The fuel cell system according to any one of claims 1 to 13, further comprising:
a contaminated wastewater line for supplying a contaminated wastewater containing a contaminant discharged from the facility; and
a contaminated wastewater purification part for purifying the contaminated wastewater supplied from the contaminated wastewater line by using heat of reaction of the fuel cell.

15. An exhaust gas purification method using a fuel cell, comprising:
a step of supplying a contaminated exhaust gas containing a contaminant discharged from a facility to a contaminated exhaust gas purification part; and
a step of purifying the contaminated exhaust gas in the contaminated exhaust gas purification part by using heat of reaction of the fuel cell.

16. A fuel cell device modification method for modifying a fuel cell device including a fuel cell to a fuel cell system for purifying a contaminated exhaust gas discharged from a facility, comprising
a step of connecting a contaminated exhaust gas line for supplying the contaminated exhaust gas discharged from the facility to an air inlet of the fuel cell.
